(19) United States
(12) Patent Application Publication
(10) Pub. No.: US 2021/0070346 A1
(43) Pub. Date: Mar. 11, 2021

(54) AIR-COOLING COVER SYSTEM FOR CHILD CARRIERS

(71) Applicants: Steve Roberts, Lutz, FL (US); Clint Chrisman, Lutz, FL (US)

(72) Inventors: Steve Roberts, Lutz, FL (US); Clint Chrisman, Lutz, FL (US)

(21) Appl. No.: 17/016,451

(22) Filed: Sep. 10, 2020

Related U.S. Application Data
(60) Provisional application No. 62/898,808, filed on Sep. 11, 2019.

(51) Int. Cl. B62B 9/14; F24F 11/30; F24F 5/00

(52) U.S. Cl. CPC B62B 9/14; F24F 2110/10; F24F 5/0017; F24F 11/30

(57) ABSTRACT

An air-cooling system cover system for enclosing a child or pet carrier or stroller and cooling the enclosed air. The system includes a cover configured to be secured to the carrier or stroller and provide enclose a space to be cooled. The cover is connected by a hose to a cooler holding cooling material, such as ice or an icepack. A temperature-controlled fan on the cooler is configured to draw cool air from within the cooler and discharge, through the hose, the cool air into the enclosed space. A temperature sensor is disposed in the enclosed space to sense the air temperature therewithin. Based on the sensed temperature the fan is off or on. An audible alarm alerts if the sensed temperature is too high or too low for safety.

### CROSS-REFERENCE TO RELATED APPLICATIONS

This application claims the benefit of U.S. Provisional Application Ser. No. 62/289,808, filed Sep. 11, 2019, the entirety of which is incorporated herein by reference.

### FIELD OF THE INVENTION

The present invention relates to portable air-cooling devices and, more particularly, pertains to an air-cooling cover system for covering child carriers, such as, for example handheld carriers or strollers, and providing cool air to a child in the carrier.

### BACKGROUND OF THE INVENTION

Ensuring comfort of a child in a child carrier is important to the child's wellbeing. In hot weather, children in child carriers can quickly become overheated and uncomfortable from exposure to the surrounding hot air and sunlight. Even in cool whether when exposed to direct sunlight, the child can become hot and uncomfortable. Accordingly, there is a need and a desire to be able to cool a child while the child is in a child carrier.

### SUMMARY OF THE INVENTION

Embodiments of the invention provide an air-cooling covering system for use with child carriers and/or strollers that operates to provide controlled, cooled air to a child to ensure the child's comfort.

An object of embodiments of the present invention is to provide an air-cooling covering system that is easy to operate.

Another object of embodiments of the present invention is to provide an air-cooling covering system that is portable and easy to assemble.

Another object of embodiments of the present invention is to provide an air-cooling covering system that prevents over cooling and alarm notifications of too cold or hot conditions.

Numerous other objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of an air-cooling covering system constructed in accordance with an embodiment of the invention, shown in-use with a child carrier;

FIG. 2 is a perspective view of a covering of the air-cooling covering system, shown exploded from a child carrier;

FIG. 3 is a perspective view of a flexible hose construction of the air-cooling covering system;

FIG. 4 is a cross-sectional view taken along line 4-4 in FIG. 1;

FIG. 5 is a first perspective of a cooling device of the air-cooling covering system;

FIG. 6 is a second perspective of a cooling device of the air-cooling covering system;

FIG. 7 is a front, cross-sectional view through the cooling device;

FIG. 8 is a block diagram of various electrical components of the air-cooling covering system; and

FIG. 9 is a perspective view of an air-cooling covering system constructed in accordance with another embodiment of the invention, shown in-use with a child stroller.

### DETAILED DESCRIPTION OF THE INVENTION

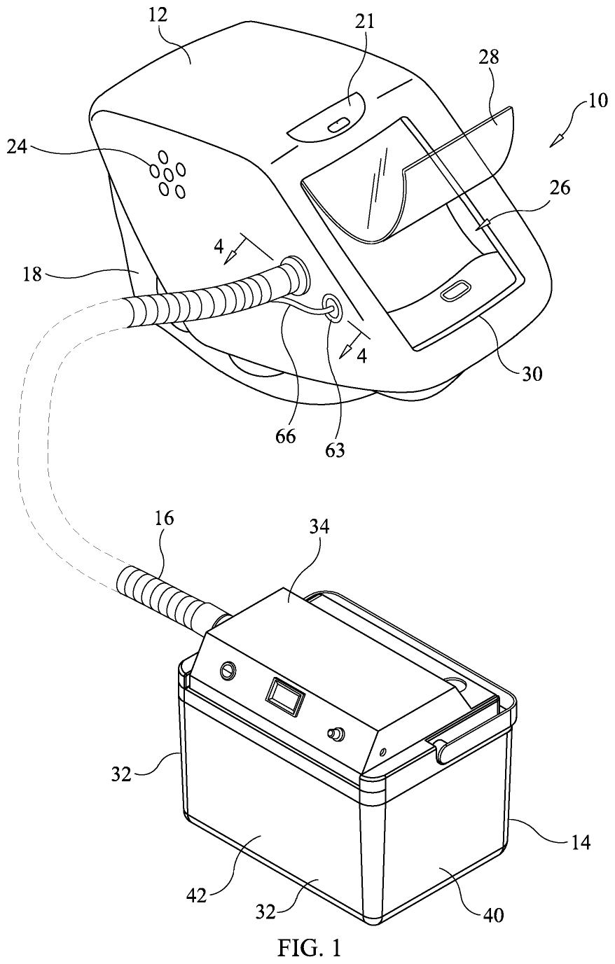

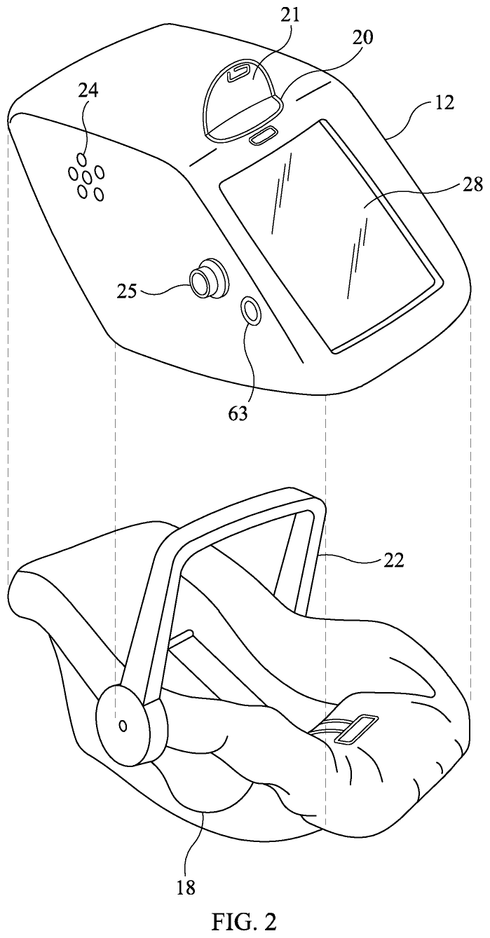

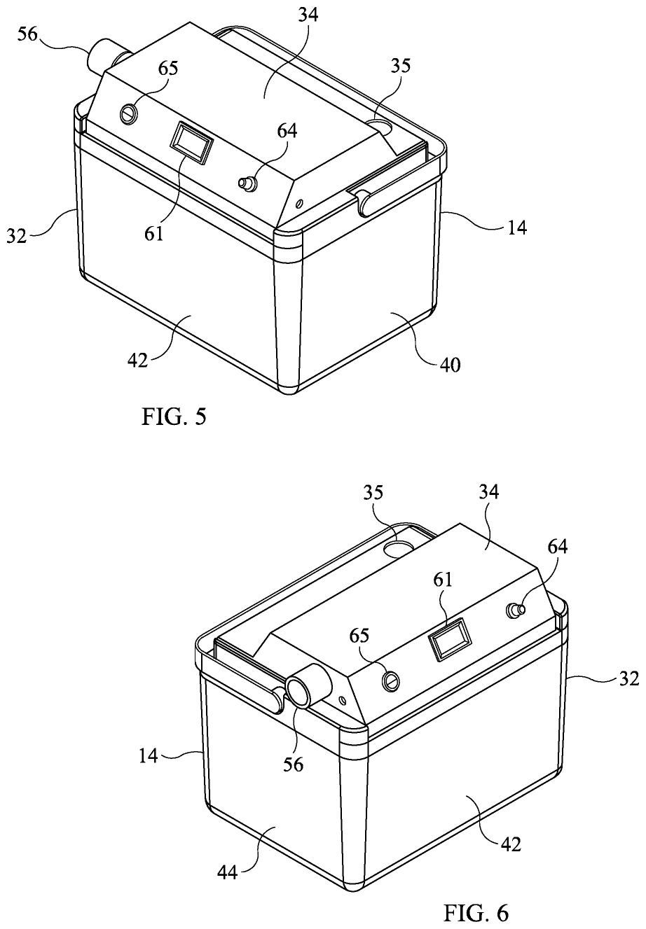

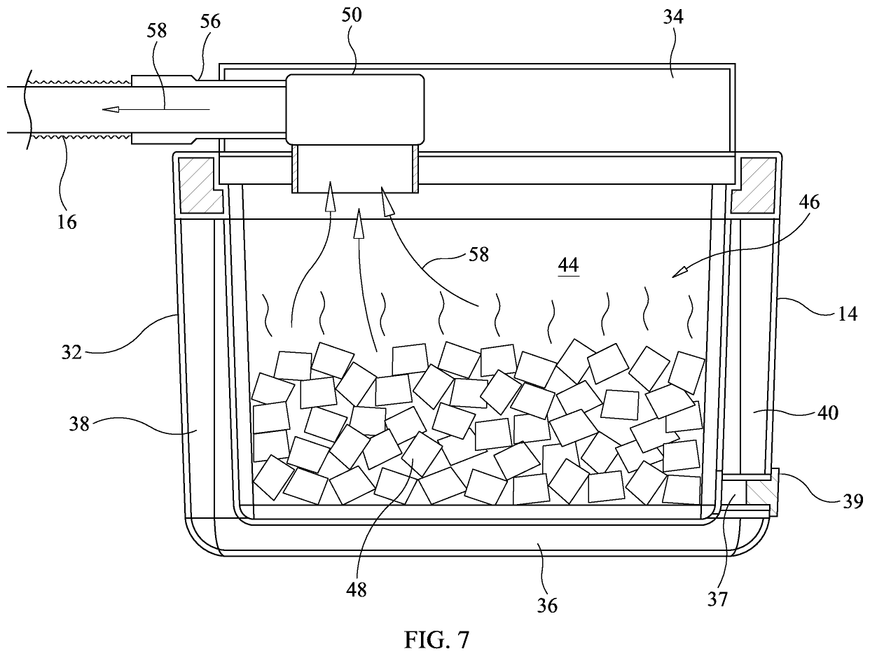

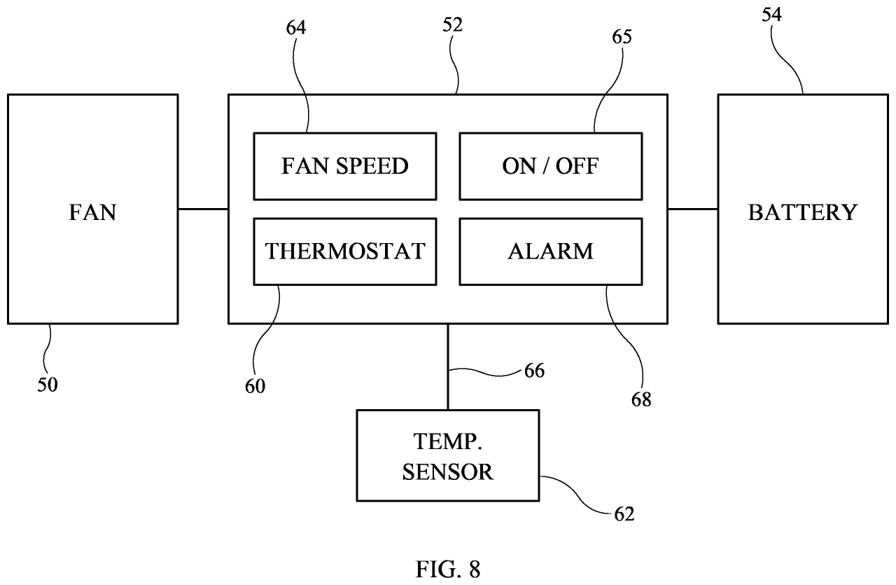

Initially, with reference to FIGS. 1 through 8 of the drawings, reference number 10 generally designates an air-cooling covering system 10 in accordance with an embodiment of the invention. Air-cooling covering system 10 includes a fabric cover 12 and an air cooler 14 that is connected to the cover by a flexible hose 16. The cover 12 is structured and configured for securement to a conventional child carrier, such as, the illustrated handheld carrier 18. The cover 12 covers the carrier 18 and provides an enclosed space that may be cooled by cool air from the air cooler via flexible hose 16. The cover 12 may be constructed from a fabric material that may be opaque to provide sunshade, the material may also have UV transmission inhibiting properties, and may be waterproof to guard against the elements.

The cover 12 includes one or more openings, representatively opening 20 for the handle 22 of the carrier to extend through to allow a person to grasp the handle when the cover is attached to the carrier 18. The opening 20 can be closed by a flap 21. The cover 12 may also include air vent holes 24 to allow air to vent from enclosed space to the exterior of the cover. The air vent holes 24 may be located through side of the cover at position that is near the head position of a child when located in the carrier 18 and may be present on one or both sides of the cover. A forced air inlet to the enclosed space is provided by an airport 25 that is attached to and extends through the side of the cover 12. The exterior end of the airport 25 is configured for removable connection to an end of the flexible hose 16.

Further, as illustrated in the representative embodiment, the cover 12 may include an access opening 26 that provides access to the enclosed space to place or remove a child from the carrier 18 and to tend to the child while located in the carrier. A transparent window 28 is attached to the cover 12 and operates to close the access opening 26 and allow observation of the child in the carrier 18. The window 28 may be removably secured to the opening 26 along adjacent edges by a suitable closure 30 such as, for example, a zipper or hook-and-loop type closures.

The cooler 14 includes an insulated box 32 having a lid 34, a bottom 36, and four sidewall 38, 40, 42, and 44 that define an interior compartment 46 for receiving and holding cooling material 48, such as, for example ice or ice packs therein. A drain 37 extends through one side wall and is sealed by a removable cap or plug 39. The drain allows water to be removed from the box 32 without having to open the lid and tipping the box over. The lid 34 is openable to allow access to the interior compartment for filling the compartment with cooling material. The lid 34 may be hingedly attached to the one or more sidewall to allow opening and closing the lid.

The cooler 14 further includes an electric fan 50, a controller 52, and an electric power source 54 that are operably connected. The fan 50 is disposed in the lid 34 and when operated, the fan draws air 58 from within the interior compartment 46 and discharges it through the duct. The exterior end of duct 56 is configured to connect to an end of the flexible hose 16 such that air 58 discharged from the duct is directed into the flexible hose. An air inlet 35 is formed through the lid and extends into the interior compartment 46 to allow air to be drawn into the interior compartment from the ambient air when the fan 50 operates.

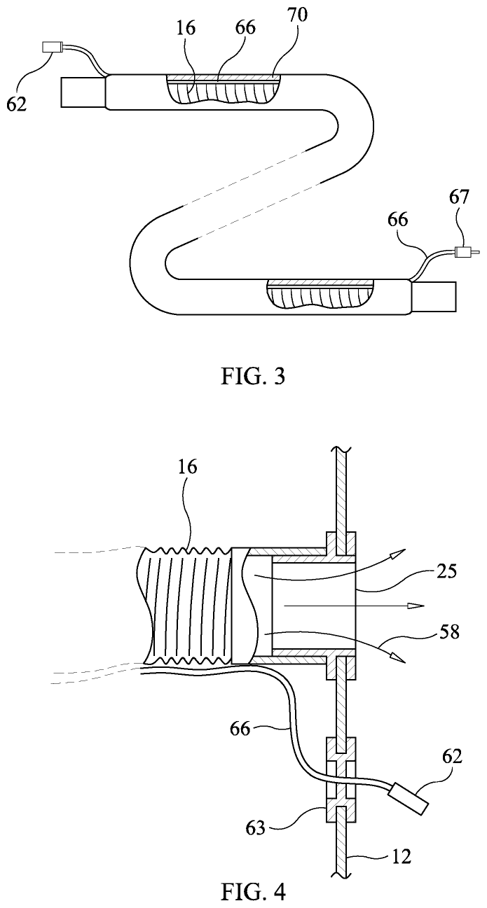

The controller 52 includes a thermostat 60 having a display 61, a temperature sensor 62, a fan speed control 64, and an off/on switch 65 that are operatively connected. The temperature sensor 62 is disposed on an interior side of the cover 12, which may have a port 63 through which the sensor may be inserted to be disposed on the interior side of the cover. The temperature sensor 62 operates to measure the air temperature within the enclosed space and is operatively connected to the thermostat by wire 66 and electrical connection 67 which plugs into electrical port 69. The flexible hose 16 can include a sleeve covering 70 (best seen in FIG. 3) through which the temperature sensor wire 66 is run along the flexible hose 16. Alternatively, the wired temperature sensor 62 could be replaced by a wireless temperature sensor. Wireless temperature sensors and related thermostats are well known to those of ordinary skill in the art.

Electric power source 54 can be a battery, a rechargeable battery, solar power, or the like. The controller 52 operates to provide electric power from the power source to the electric fan 50. The fan speed can be controlled by the fan speed control 64.

In operation, the thermostat 60 is set to a desired temperature for the enclosed space, such as, for example a temperature of 74-degrees Fahrenheit. When the temperature of the enclosed space, as measured by the temperature sensor 62 is higher than the setpoint temperature by a threshold value, such as two degrees, the thermostat operates to connect the power source 54 to the fan 50 so that the fan turns on and draws cool air 58 from within the interior compartment 46 and discharge the cool air through the hose 16 and into the enclosed space. The speed of the fan 50 may be increased or lowered by a user adjusting the fan speed control 64. Once the temperature of the enclosed space, as measured by the temperature sensor 62, drops below the setpoint temperature a threshold value, such as two degrees, the thermostat operates 60 operates to disconnect the fan 50 from the power source 54.

In embodiments, the controller 52 may include an audible alarm 68 and the controller may be configured to turned on the audible alarm when the temperature of the enclosed space, as measured by the temperature sensor 62, is higher than a high temperature setpoint or lower than a low temperature setpoint. To this end, if the temperature of the enclosed space rises beyond the high temperature setpoint, the alarm 68 with alert and inform the user that the temperature of the enclosed space is high, indicating the cooler is not cooling the enclosed space as desired. Similarly, if the temperature of the enclosed space rises beyond the low temperature setpoint, the alarm with alert and inform the user that the temperature of the enclosed space is low, indicating the cooler is not cooling the enclosed space as desired.

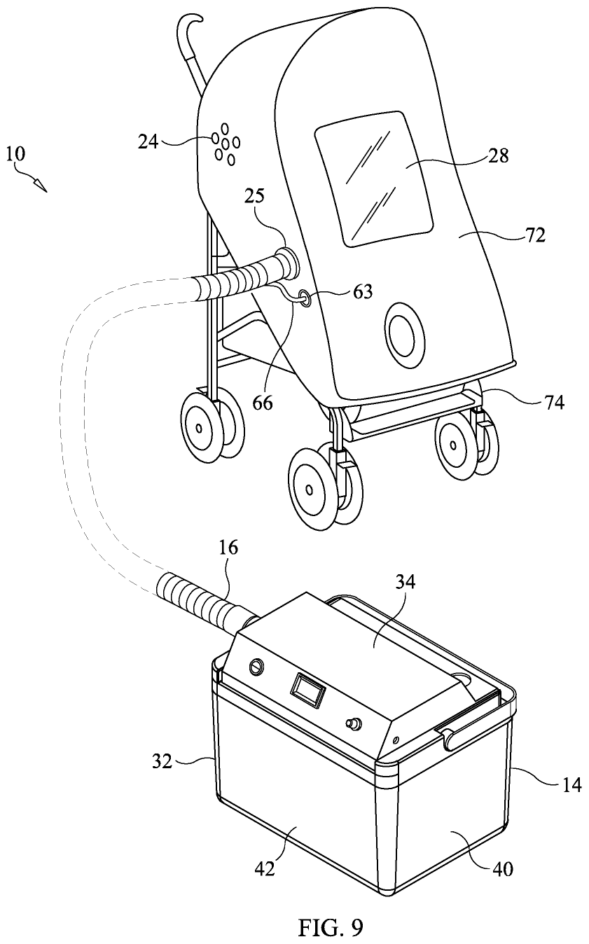

In FIG. 9, the cooling system 10 may include a covering 72 that is shaped to cover a stroller 74. Cover 72 is constructed like cover 12 but doesn't include the opening 20 or flap 21 that is desired for use with a child carrier 18 to grasp its handle. Additionally, while not shown, the system 10 may include clips, brackets, straps, or the like, that can be attached to the stroller 74 and hold the cooling device 14 by its handle, for example. In this manner, the cooling device 14 would be secured to the stroller 74 and would not require a user to separately hold the cooling device.

While the invention has been particularly shown and described with respect to the illustrated embodiments thereof, it will be understood by those skilled in the art that the foregoing and other changes in form and details may be made therein without departing from the spirit and scope of the invention.

For example, the forgoing technical disclosure can be applied to pet carriers and strollers without departing from the scope of the invention. Ensuring the comfort of a pet by conditioned air while using a pet carrier or stroller is also important. And accordingly, the invention can equally be used for that purpose.

Additionally, while not shown, the system 10 could be configured to work with software that is installed on a computing device. The computing device could be a mobile smart device, such as, but not limited to a smart watch, a smart telephone, computer tablet, or the like. The system could communicate with the computing device using any known and desirable wireless communication protocol, such as, for example Bluetooth®, WiFi, nearfield, cellular, etc. Using the software, on the computing device, the system could be configured to be controlled via the computing device, such as, for example to set the desired temperature, to turn the system on/off, and to receive operation alerts. Operation alerts could include high temperature, low temperature, low battery, or other alerts as desired.

What is claimed is:

1. An air-cooling cover system comprising:
a cover configured to be secured to a carrier or stroller and provide an enclosed space to be cooled, the cover having a forced air inlet into the enclosed space defined by an airport that is attached to and extends through a side of the cover;
a cooler having an insulated box having an interior compartment for receiving and holding cooling material therein;
a fan on the cooler and configured to draw cool air from within the interior compartment and discharge the cool air externally from the interior compartment through an air duct;
an air communicating hose connected at one end to the airport of the cover and connected at its opposite end to the duct of the cooler;
an electric power source;
a controller having a thermostat and a temperature sensor, the temperature sensor disposed within the enclosed space to measure the air temperature of the enclosed space; and
the electric power source being connected to the fan to cause the fan to draw cool air from the interior compartment and discharge the cool air into the enclosed space through the air communicating hose when the air temperature of the enclosed space is higher than a setpoint temperature as sensed by the temperature sensor.

2. The system of claim 1, wherein the electric power source is a rechargeable battery.

3. The system of claim 1, wherein the controller further comprises an audible alarm that is activated when the air temperature of the enclosed space as sensed by the temperature sensor is above a high temperature setpoint or lower than a low temperature setpoint.

4. The system of claim 1, wherein the air communicating hose is removably attached at its opposite ends to the airport and the duct.

5. The system of claim 1, wherein the cover further includes vent holes through the sidewall of the cover.

6. The system of claim 1, wherein the cover further includes an access opening that provides access to the enclosed space, and a transparent window attachable to the cover to close the access opening.

7. The system of claim 1, wherein the cooler further includes an air inlet to allow air to be drawn into the interior compartment from the ambient air.

8. The system of claim 1, wherein the temperature sensor is wirelessly connected to the thermostat.

9. The system of claim 1, wherein the thermostat has a display for displaying the temperature of the enclosed space as sensed by the temperature sensor, and the setpoint temperature.

10. The system of claim 1, wherein the fan is a variable speed fan.

11. An air-cooling cover system comprising:
a cover configured to be secured to a carrier or stroller and provide an enclosed space to be cooled, the cover having a forced air inlet into the enclosed space defined by an airport that is attached to and extends through a side of the cover;
a cooler having an insulated box having an interior compartment for receiving and holding cooling material therein, the cooler having an air duct for communicating air from the interior compartment to exteriorly of the cooler through an airport disposed on an exterior of the cooler;
a fan on the cooler and configured to draw cool air from within the interior compartment and discharge the cool air externally from the interior compartment through the duct, the fan being a variable speed fan;
an air communicating hose removably connected at one end to the airport of the cover and removably connected at its opposite end to the duct of the cooler;
an electric power source;
a controller having a thermostat, a temperature sensor, and audible alarm, the temperature sensor disposed within the enclosed space to measure the air temperature of the enclosed space;
the electric power source being connected to the fan to cause the fan to draw cool air from the interior compartment and discharge the cool air into the enclosed space through the air communicating hose when the air temperature of the enclosed space is higher than a setpoint temperature as sensed by the temperature sensor; and
the audible alarm being activated when the air temperature of the enclosed space as sensed by the temperature sensor is above a high temperature setpoint or lower than a low temperature setpoint.

12. The system of claim 11, wherein the electric power source is a rechargeable battery.

13. The system of claim 11, wherein the cover further includes an access opening that provides access to the enclosed space, and a transparent window attachable to the cover to close the access opening.

14. The system of claim 11, wherein the cooler further includes an air inlet to allow air to be drawn into the interior compartment from the ambient air.

15. The system of claim 11, wherein the temperature sensor is wirelessly connected to the thermostat.

16. The system of claim 11, wherein the thermostat has a display for displaying the temperature of the enclosed space as sensed by the temperature sensor, and the setpoint temperature.
